(19) United States
(12) Patent Application Publication
(10) Pub. No.: US 2025/0028422 A1
(43) Pub. Date: Jan. 23, 2025

(54) 3D Application Accessed by Streaming with Audio, Video, and Chat Communications

(71) Applicant: Headoffice.Space Inc., Wilmington, DE (US)

(72) Inventors: Marco Antonio Martins De Carvalho, JR., Torrance, CA (US); Gilliard Pereira Araujo, Orindiuva (BR); Iago Zapletal, Belo Horizonte (BR); Ivan Esteban Zorn, Torrance, CA (US); Gurmeet Singh, Sri Muktsar Sahib (IN)

(21) Appl. No.: 18/355,082

(22) Filed: Jul. 19, 2023

(51) Int. Cl. G06F 3/04815; G06F 3/04845; H04L 65/1045; H04L 65/1089; H04L 65/1093

(52) U.S. Cl. CPC G06F 3/04815; G06F 3/04845; H04L 65/1045; H04L 65/1089; H04L 65/1093

(57) ABSTRACT

Exemplary embodiments include systems and methods for generating an immersive environment. Exemplary embodiments of the systems and methods may use a server for creating a persistence session of the virtual three-dimensional immersive environment. Exemplary embodiments of the systems and methods may include a streaming matchmaking server to initiate virtual machines to support the expansion of the system as users enter and leave the environment. Exemplary embodiments of the systems and methods include unique attributes of navigating and controlling the virtual environment to permit peer to peer interactions, share information between users, access programs, among other features and components described herein.

### BACKGROUND

Current systems permit communication between users by connecting individual users through a single interface. For example, two or more users may join the same chat platform, connect to each other, and send chat messages to each through the platform. If the users then want to participate in a teleconference, they would log into another program to a web conferencing system to see and talk to each other. There are also gaming systems that permit a user to enter a virtual reality or augmented space and move around an environment.

However, there is no integrated system that permits a user to immerse into a virtual or augmented reality environment and experience different selected experience for sharing and communicating.

### SUMMARY

Exemplary embodiments described herein include systems and methods for communication through an electronic interface. Exemplary embodiments may include three dimensional representations that may be experienced in a two dimensional environment (such as a screen) or a three dimensional environment (such as an augmented or virtual reality environment). Exemplary embodiments may include systems and methods for permitting streaming with audio, streaming with video, file sharing, communication, text communications, or a combination thereof within the environment. Exemplary embodiments may permit access and/or integration of one or more electronic systems to provide a unified platform for data sharing and communication.

Exemplary embodiments described herein may use real-time streaming, video streaming, audio streaming, text communication, document sharing, data sharing, etc. Exemplary embodiments may use web interfaces, to access a platform so that a specific program is not required to be downloaded and run on a user's device. Accordingly, exemplary embodiments permit access to the system to access its platform through a Uniform Resource Locator (URL) address without running a local program on the user's device.

Exemplary embodiments of the systems and methods described herein may avoid the need to install specific software or programs onto a user's device. Instead, exemplary embodiments use remote access through a network to access the platform.

Exemplary embodiments of the system and method provide a new and unique video experience in which the user may perform and observe actions instead of simply or only a view of other user's face as obtained by the other user's camera.

Exemplary embodiments of the system and method to bring realism to the digital communications using spatial audio providing user's more cognitive comfort by approaching the way sound works in the real world.

Exemplary embodiments may be used to integrate different web platforms that can access a web browser within a web3.0 application.

### BRIEF DESCRIPTION OF DRAWINGS

FIG. 1 illustrates an exemplary architecture of a web based platform grouped into layers for efficient and persistent management of the immersive experience.

FIGS. 2A-2D illustrates and exemplary user interfaces of a front end according to embodiments of the invention.

FIGS. 3A-3B illustrate an exemplary block diagram of a system architecture according to embodiments of an immersive system described herein.

FIGS. 4A-4B illustrate an exemplary block diagram of a system architecture according to embodiments of an immersive system described herein.

FIGS. 5A-5D illustrate an exemplary method for using the platform according to embodiments described herein.

FIG. 6 illustrates an exemplary system diagram according to embodiments described herein.

### DESCRIPTION

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements.

In addition, the terms “unit”, “-er”, “-or”, and “module” described in the specification mean units for processing at least one function and operation, and can be implemented by hardware components or software components and combinations thereof.

In this document, when terms such as “first” and “second” are used to modify a noun, such use is simply intended to distinguish one item from another, and is not intended to require a sequential order unless specifically stated. In addition, terms of relative position such as “vertical” and “horizontal”, or “front” and “rear”, when used, are intended to be relative to each other and need not be absolute, and only refer to one possible position of the device associated with those terms depending on the device's orientation.

An “electronic device” or a “computing device” refers to a device that includes a processor and memory. Each device may have its own processor and/or memory, or the processor and/or memory may be shared with other devices as in a virtual machine or container arrangement. The memory may contain or receive programming instructions that, when executed by the processor, cause the electronic device to perform one or more operations according to the programming instructions.

The terms “memory,” “memory device,” “computer-readable storage medium,” “data store,” “data storage facility” and the like each refer to a non-transitory device on which computer-readable data, programming instructions or both are stored. Except where specifically stated otherwise, the terms “memory,” “memory device,” “computer-readable storage medium,” “data store,” “data storage facility” and the like are intended to include single device embodiments, embodiments in which multiple memory devices together or collectively store a set of data or instructions, as well as individual sectors within such devices.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

The terms “instructions” and “programs” may be used interchangeably herein. The instructions may be stored in object code format for direct processing by the processor, or in any other computing device language, including scripts or collections of independent source code modules that are interpreted on demand or compiled in advance. Functions, methods, and routines of the instructions are explained in more detail below. The instructions may be any set of instructions to be executed directly (such as machine code) or indirectly (such as scripts) by the processor. For example, the instructions may be stored as computing device code on the computing device-readable medium.

The term “data” may be retrieved, stored or modified by processors in accordance with a set of instructions. For instance, although the claimed subject matter is not limited by any particular data structure, the data may be stored in computing device registers, in a relational database as a table having a plurality of different fields and records, XML documents or flat files. The data may also be formatted in any computing device-readable format.

The term “module” refers to a set of computer-readable programming instructions, as executed by a processor, that cause the processor to perform one or more specified function(s).

Although exemplary embodiments are described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute these modules to perform one or more processes that are described further below.

Further, the control logic of the present disclosure may be embodied as non-transitory computer readable media on a computer readable medium containing executable programming instructions executed by a processor, controller, or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network-coupled computer systems so that the computer readable media may be stored and executed in a distributed fashion such as, e.g., by a telematics server or a Controller Area Network (CAN).

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

Exemplary embodiments of the systems and methods described herein permit a three dimensional application accessed through a web interface by streaming audio, video, chat communications, and combinations thereof.

Exemplary embodiments of the immersive environment permits an entity to build a store or other interface for selling products. As access may be provided through a web address (URL), an entity may imbed exemplary embodiments of the present platform into an entity's website. The entity may plug in their product, customer and loyalty program databases, payment gateways, or a combination thereof. The entity may then start selling in the immersive environment.

Exemplary embodiments of the immersive environment permits users to host events, conferences, file sharing, screen sharing, audio conferencing, video conferencing, or a combination thereof.

Exemplary embodiments may permit users to create segregated immersive experiences for users. In an exemplary embodiment, areas may be created for different user purposes. For example, a room may be created in which one or more users may meet and experience a conference meeting, a room may be created in which a user may mimic an office and/or computer interface of a work area, a room may be created in which a user may mimic a store, an area may be created such as an outside environment, room, space, etc. In an exemplary embodiment, areas may be created to provide models, presentations, mockups, product images or three dimensional virtual renderings, or a combination thereof.

Exemplary embodiments may permit restricted access areas. Areas, such as accessed through a gate, door, room, etc. may require a user to enter user credentials or access information before access is granted to restricted areas and/or information contained within the restricted area.

Exemplary embodiments may be used to create digital versions of an environment. For example, a company may recreate an office space or a school may create classrooms. Exemplary embodiments may be used to create virtual environments that bring people together in an environment able to support integration of users in the virtual world. Exemplary embodiments may therefore be used for remote working or learning environments, but may be used for other activities, such as, for example, shopping, research, advise, meetings, etc.

Exemplary embodiments may permit integration with digital products and web2 tools, such as social media interfaces, document tools, rendering and visual tools, spreadsheet tools, presentation tools, etc. For example, exemplary embodiments may use or access youtube, twitter, gmail, google slides, google sheets, outlook excel, word, powerpoint, airtable, miro, mural, powerbi, or others.

Exemplary embodiments permit login through different methods. For example, SSO or social media may be used to log in to the platform.

Exemplary embodiments permit a persistent immersive environment.

Exemplary embodiments described herein may provide a cloud metaverse operating system. Exemplary embodiments may therefore permit third parties to integrate different programs and systems into the immersive environment. Exemplary embodiments may incorporate any combination of performance, security, productivity, and interoperability.

Exemplary embodiments described herein may be achieved by creating a webpage that is grouped into layers.

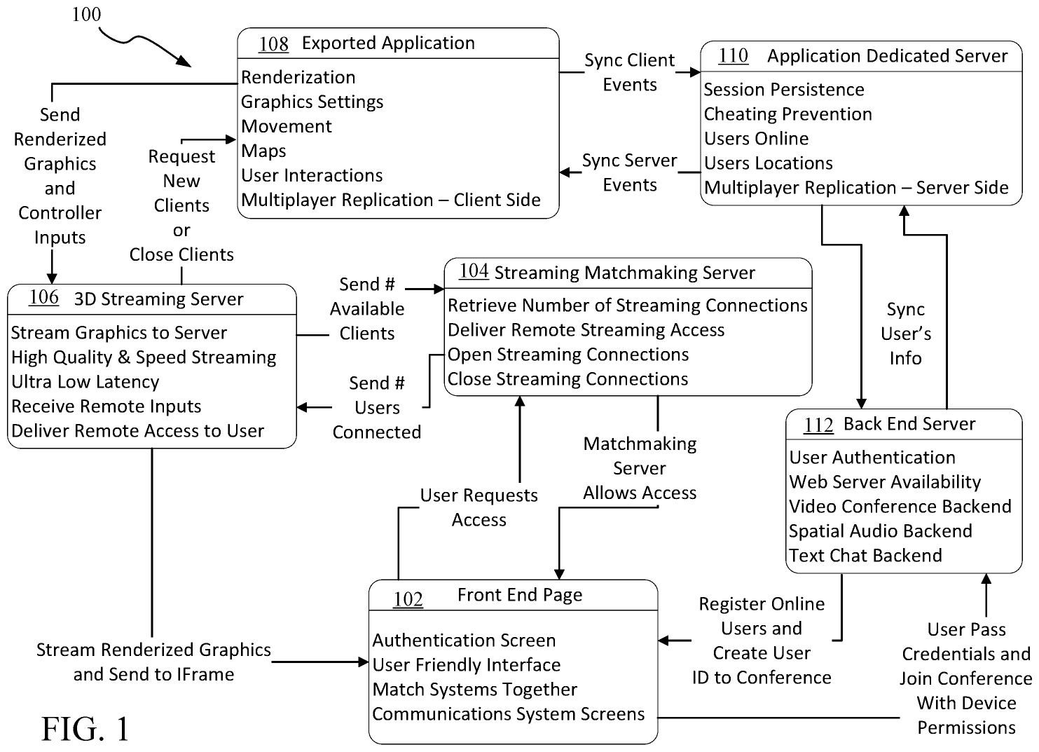

FIG. 1 illustrates an exemplary flow diagram depicting the three dimensional application streaming method used by a dedicated server for streaming the application exported by a three dimensional creation tool.

FIG. 1 illustrates an exemplary architecture of a web based platform grouped into layers for efficient and persistent management of the immersive experience. Exemplary embodiments of the layered architecture are configured to permit session persistence as users enter and leave the platform. Exemplary embodiments may be used for persistence so that no one person controls a meeting experience and/or are needed to initiate a communication at any given time. Exemplary embodiments of the layered architecture are configured to balance the server requirements so that the platform can support any and dynamic numbers of users. Exemplary embodiments may therefore open or close connections to support the streaming requirements of the platform as users enter and leave the platform. The system may therefore have sufficient processing power dynamically without the need for a dedicated server processor to accommodate the maximum number of users, in which the processing power may remain unused when the maximum number of users are not engaged with the platform. Exemplary embodiments of the layered architecture may be used to manage the three dimensional streaming to provide an immersive experience that can include high quality rendering with sufficient speed for low latency. Exemplary embodiments can permit graphical rendering to create an enjoyable streaming experience. Exemplary embodiments of the layered architecture may be used to create a user-friendly interface. Exemplary embodiments of the user interface may be used to authenticate a user, provide access to the platform, provide user friendly combinations of visual immersive environments with or without communication interfaces for select communications in video, audio, data, electronic media, and/or text between users and/or programs.

In an exemplary embodiment, the system architecture may include a layer for a front-end page 102 for end user access. The front-end page 102 may provide a user interface configured to be displayed on an electronic device, such as through a display screen, virtual reality system, augmented reality system, or a combination thereof. The front-end page 102 may be configured to be rendered on a web browser. In an exemplary embodiment, the front-end page 102 may be configured to display a user login configured to receive user login credentials from a user. Exemplary user credentials may be a username, password, biometric, image, etc. or a combination thereof. For example, the user interface may be configured to permit the user to enter a username and password. The user may also or alternatively permit a user to link a media account, such as through a Linkedin®, Google®, or other account.

In an exemplary embodiment, the system architecture may include a layer for a back-end server 112. In an exemplary embodiment, the back-end server 112 may be configured to store information relevant to the authentication requirements of the system. For example, the back-end server may be configured with a database to store user credentials for the platform and/or for the conferencing and/or programs that are related to or accessible through the platform. The back-end server 112 may be configured to receive credentials, determine the authentication of the user using stored information/credentials and/or accessed or received information, with the received credentials. Exemplary embodiments of the back-end server 112 may be configured to manage the communication with the user. For example, the back-end server 112 may be configured to provide text backend, audio backend, video backend, etc. In an exemplary embodiment, the audio is configured to be provided to the user in a spatial configuration so that sound seems to originate from a user associated with the speaking, or in which sound is generated in a special orientation relative of the user's avatar relative to the object (or other user) creating the sound generating the audio. In an exemplary layer, the system may include a back-end server 112 to support the web platform.

In an exemplary embodiment, the front-end page 102 may be configured to communicate with the back-end server 112. For example, the front-end page may communicate through the browser or conventional browser protocols to communicate from the device of the user (such as a computer, phone, laptop, virtual reality googles, augmented reality device, etc.) to the back-end server. The system may be configured to send the user information including login credentials to the back-end server and receive confirmation of user authentication based on data stored at the back-end server. The front-end page and the back-end server may also be configured to pass credentials to join conferences, join communication interfaces, enter protected areas, or other credential requirements as described herein.

In an exemplary embodiment, the system architecture may include a layer for an application dedicated server 110. In an exemplary embodiment, the application dedicated server 110 may be configured to provide session persistence. Having a dedicated server, the platform may be maintained in time so that the presence or absence of any one or more users is not necessary to maintain the environment for other users to come and go. Conventional communication systems require a user to initiate a communication session in which others may then join once the session is initiated. Permitting session persistence allows users to come and go as the need arises for communication. Session persistence may also permit communication in which the organizer may be late or unavailable.

Exemplary embodiments of the application dedicate server 110 may also or alternatively include other features. For example, the application dedicated server may manage cheating. The application dedicated server 110 may track the users on the platform, and their associated locations. In an exemplary embodiment, the location of the respective users tracked by the application dedicated server 110 may be communicated with the back-end server 112 to provide directional or spatial audio when delivering audio to the front-end 102 so that a user may experience directional audio when communicating with different users, and/or hear sounds from the virtual environment. Exemplary embodiments of the application dedicated server 110 may also or alternatively provide multiplayer replication. In an exemplary embodiment, the back-end server 112 may be separate from the application dedicated server 110.

In an exemplary embodiment, the system may include an application dedicated server 110 for persistent connection. Exemplary embodiments may therefore permit users to enter and leave the same environment and/or take advantage of different areas of the same environment. In other words, exemplary embodiments permit multiple users to independently join the same session, independent of where the user enters or navigates within the three-dimensional environment or within the application. In an exemplary embodiment, the entry into the three-dimensional environment does not depend on the initiation of a session by any one or more users in order for other users to join the environment.

In an exemplary embodiment, the system architecture may include a layer for exported application 108. The exported application 108 may be configured to provide graphic rendering and gameplay mechanics produced with a three-dimensional creation tool. In an exemplary embodiment, the exported application layer 108 may be configured to manage user interactions, maps, movement of avatars, graphics settings, or a combination thereof.

In an exemplary embodiment, the exported application layer 108 may be configured to communicate through the three-dimensional streaming server 106 to provide rendered graphics to the user to be displayed on the user interface or front-end page 102. For example, the graphical user interface may be presented to a user as a three-dimensional environment. In an exemplary embodiment, the user may be represented as an avatar that can be maneuvered through the three-dimensional environment. The user interface may permit different user views of the avatar, such as from a perspective including the user's avatar, as if from the perspective or view of the avatar, or other viewpoint. The gameplay mechanics managed by the exported application 108 may control the movement within the three-dimensional environment, including, for example, the avatar location, perspective orientation, maps, in-application functions, multiplayer replication, etc. In an exemplary embodiment, the three-dimensional creation tool may be, for example, Unreal Engine through Blueprints, C++, JSon, or other programming languages with appropriate application programming interface (API) integrations. In an exemplary embodiment, the exported application 108 may also communicate with the application dedicated server 110 in order to track user locations within the environment and/or the users and/or the multiplayer replication.

In an exemplary embodiment, the system architecture may include a layer for a three-dimensional streaming server 106. In an exemplary embodiment, the system may include a three-dimensional application streaming management server 106. The three-dimensional application streaming management server may be configured to stream graphics to the front-end page to be displayed to the user. The exemplary three-dimensional streaming server may provide high quality and fast streaming. The resulting streaming server may be configured to provide ultra-low latency so that a user may perceive continued and smooth animation of the environment as users navigate and move through the platform.

In an exemplary embodiment, the three-dimensional streaming server 106 may be separated from the application dedicated server 110 and the back end server 112. As described herein, the separation of a server may not be a physical separation, but in separation of processing power. A separate processor may be used to manage the three-dimensional streaming, and the application, and back-end for authentication (etc.) The separation of the processing for distinct functions may be used to provide a persistent environment that provides for an immersive three-dimensional environment that can be streamed in high quality and with low latency.

In an exemplary embodiment, the system architecture may include a layer for server management. In an exemplary embodiment, the system may be configured to identify the streaming connections and open and/or close connection to support the streaming capabilities of the platform. In an exemplary embodiment, the system may include a matchmaking management server for streaming connections 104. As a user enters the system through the front-end 102, the system may communicate with the streaming matchmaking server 104 to ensure the new user has sufficient processing in order to support the inclusion of the new user on the platform. As new users enter the platform, the streaming matchmaking server 104 may be configured to add virtual machines to the system to support the processing of the platform. In an exemplary embodiment, the system may be containerized in a self-scaling virtual machine managed by the streaming matchmaking server 104.

Exported application is made available on a source virtual machine, configured to monitor its hardware resources periodically and auto-scale when necessary. For example, when more clients are required than the same machine supports, then the additional requirements to support the system may be added.

In an exemplary embodiment, the servers and applications may be housed in cloud servers and/or virtual machines accessible by users, without a dependency on the presence of any one or more users.

Exemplary embodiments described herein include methods of providing three dimensional immersive experiences.

In an exemplary embodiment, a user accesses the application via the web platform and automatically start the processes on the servers. The user may view the application through the front-end page 102.

In the exemplary method, the back-end server 112 registers the user and permits user access when the user is authenticated. The back-end server may also or alternatively provide access to video call, spatial audio, text chat, and/or other services provided on the platform.

Exemplary embodiments permit virtual machine security settings configured to check for access and malicious processes carried out in the background.

In the exemplary method, the three-dimensional application streaming server 106 may check the running application. The three-dimensional application streaming server 106 may make a connection request to the matchmaking server 104 for streaming. Exemplary embodiments of the three-dimensional application streaming server 106 may be based on NodeJS, WebRTC, WebGL, or a combination thereof.

In an exemplary embodiment of the method described herein, the matchmaking server may confirm streaming access and request a new client to be accessed. The matchmaking server 104 may be based on NodeJS. Exemplary embodiments of the matchmaking server 104 may be configured to ensure that there are always clients available to be accessed.

In an exemplary embodiment of the method, the dedicated server connects the remote user and puts him/her inside the application with his/her avatar. In an exemplary embodiment, the application dedicated server 110 may be based on the programming language C++.

In an exemplary embodiment of the method, the virtual machine escalation process may automatically open a new client and repeat the previous processes when a new user enters the platform.

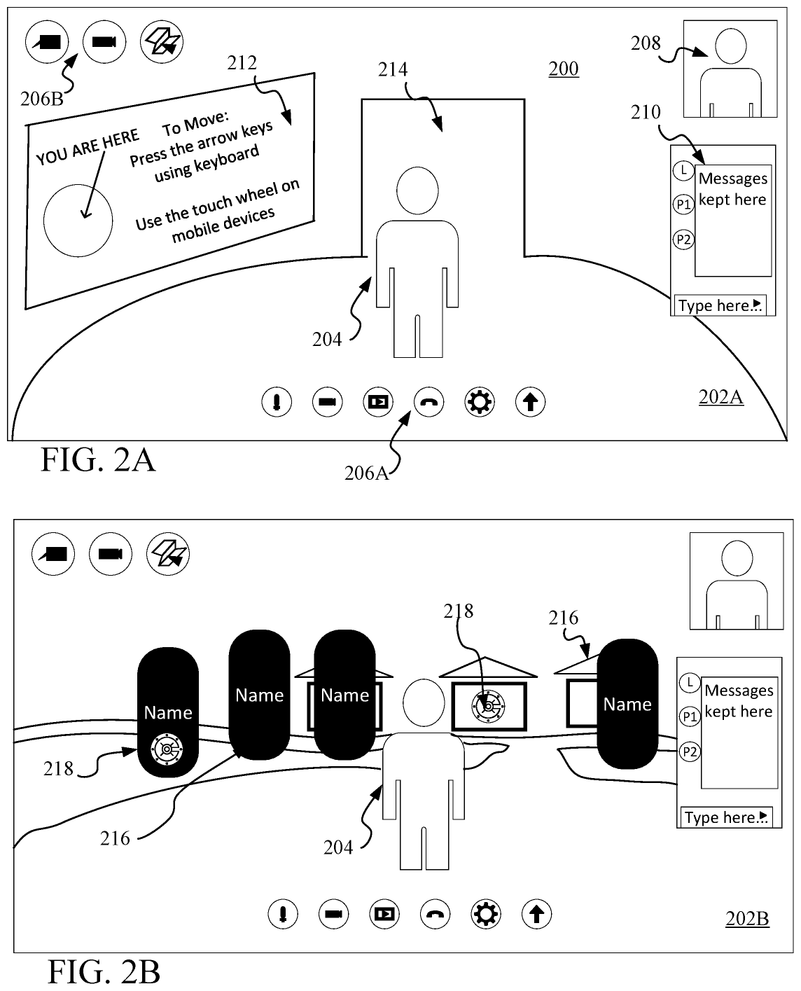

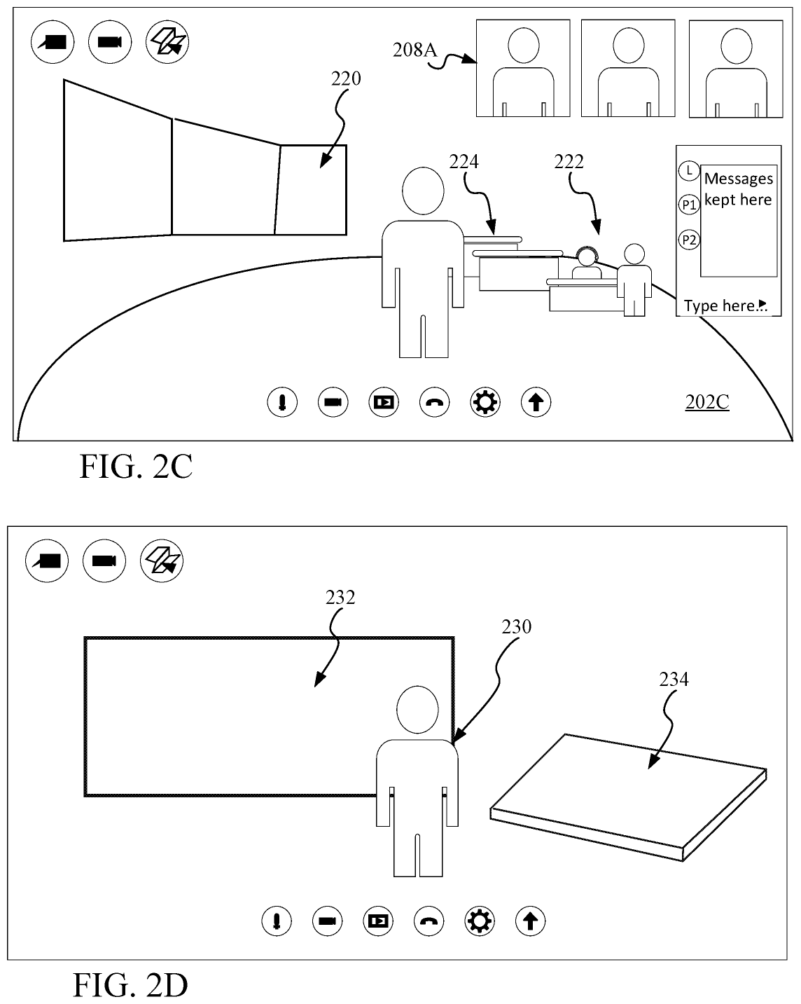

FIGS. 2A-2D illustrate exemplary user interfaces of a three-dimensional immersive environment 200 according to embodiments described herein. Exemplary embodiments of the system may be configured to display the three-dimensional immersive environment to a user, such as through the front-end page 102. The illustrations of FIGS. 2A-2C are rudimentary for illustration purposes only. The platform is configured to provide three-dimensional and virtual representations to the user to provide a fully immersive experience. Exemplary embodiments of the functions described herein with respect to the illustrated user interface may be used in any combination with the system shown and described with respect to the system of FIG. 1. The embodiments described herein are therefore not intended to be mutually exclusive.

FIG. 2A illustrates a first representative immersive environment 202A according embodiments described herein. The front-end page 102 of the immersive platform may be configured to perform the functions of generating a first representative immersive environment as described herein. The front-end page 102 may also be configured to generate parts or portions of the user interface as described herein. For example, the avatar may be used, the rooms and/or environments, the portals for information sharing, such as screens, displays, computers, pictures, etc., or any combination thereof may be used in any combination. The exemplary embodiment is illustrative only and is not limiting to require all such described features to be present in all immersive environments encompassed hereby.

The user is represented in the immersive environment as an avatar 204. The avatar may be dressed appropriate to the environment. For example, if the environment is on the moon or under the water, the avatar may wear appropriate protections, such as suits, breathing apparatus, masks, etc. In an exemplary embodiment, the user may select an avatar, and/or may select one or more attributes of the avatar, such as gender, color, height, etc.

As illustrated, the first representative immersive environment 202A is a room having a floor, wall, and door 214. The user may move the avatar and/or orient the avatar 204 so that the user may move around the immersive environment, such as around the room and/or through the door 214. The room may comprise objects in the environment. The objects 212 may be configured to provide information to the user. For example, the object 212 may be illustrated as a screen, picture, or other image. The object 212 may provide either static or dynamic information.

In an exemplary embodiment, the illustrative first representative immersive environment 202A may be an initial room or entrance room into the platform. The first representative immersive environment may provide information to the user on how to use and/or navigate the environment. As illustrated, the object 212 may provide information on how to move through the environment and/or identify a map and location of the user's avatar in the environment.

In an exemplary embodiment, the user interface of the immersive environment may include other interface segments in order to provide the user control of the system. For example, the user interface may include one or more control icons 206A, 206B. The control icons 206A, 206B may be used to permit the user to control portions of the system or provide user inputs into the system. For example, as illustrated, the control icons may include selections for starting text messages, display a map, turn on a microphone for an audio communication, settings, open control options, share screen or data with others, etc.

In an exemplary embodiment, the user interface of the immersive environment may include other interface segments. For example, the user interface may include an image of the user 208 or of other users that may be displayed to others. For example, the user interface may include an interface for sharing texts 210. The text portal 210 may be configured to exchange messages between the user and a single individual, and/or to a group of individuals, and/or to all individuals on the platform.

In an exemplary embodiment, the system is configured to receive user input to control the avatar within the system and/or move the user through the platform. For example, the user may use keys of a keyboard, mouse movements, manual movements of controllers and/or detected gestures to travel within the immersive environment. In an exemplary embodiment, the avatar of the user may be configured to move around the room 202A, or may be configured to exit the room through the door 214. The system may be configured to display to the user different representative immersive environments through the user interface as the user moves through the immersive environment.

FIG. 2B illustrates a second representative immersive environment 202B according to embodiments described herein. The front-end page 102 of the immersive platform may be configured to perform the functions of generating a second representative immersive environment as described herein. The front-end page 102 may also be configured to generate parts or portions of the user interface as described herein. For example, the portals may be used in any illustrated embodiment described herein, alone or in combination with other features. The exemplary embodiment is illustrative only and is not limiting to require all such described features to be present in all immersive environments encompassed hereby.

As illustrated, the second representative immersive environment 202B is a representation of an outdoor environment. As illustrated, the front-end page may be configured to provide a user interface to a user. The user interface may include areas in which the navigate to travel. The second representative immersive environment 202B may include objects 216. The objects may include portals. As illustrated, the portals may be configured to permit the user to enter a designed space within the virtual immersive environment. For example, the areas may be illustrated as a room or house. As illustrated, the portals may be configured to permit the user to contact the portal and transport to different areas within the virtual environment. The portal may alternatively or also be configured to connect a group of users, such as for a meeting or other communication sharing. Exemplary embodiments may therefore be configured to permit a user to control the system by navigating to areas within the virtual environment.

As illustrated, the user interface may be configured to prevent the avatar from entering a portal. For example, an area of the immersive environment may be blocked to prevent unauthorized users from entering the area. The blocked area may be indicated with a lock 218, fence, door, or other barrier. When the avatar within the user interface approaches, touches, or otherwise engages the blocked object, the system may authenticate a user. The authentication may be by identifying the user to confirm the user has access to the area, and/or may request the user put in an access credential. The system may then be configured to confirm the authentication of the user to that specific area. The blocked areas may be used to restrict access of other users to a given meeting, information sharing, space, etc.

FIG. 2C illustrates a third representative immersive environment 202C according to embodiments described herein. The front-end page 102 of the immersive platform may be configured to perform the functions of generating a second representative immersive environment as described herein. The front-end page 102 may also be configured to generate parts or portions of the user interface as described herein. For example, objects may be used in any illustrated embodiment described herein, alone or in combination with other features. The exemplary embodiment is illustrative only and is not limiting to require all such described features to be present in all immersive environments encompassed hereby.

As illustrated, the third representative immersive environment 202C is a representation of an indoor environment. The immersive environment may include other users 222. The user, through their avatar, may be configured to navigate to another user and interact with the other user. For example, the system may be configured to permit the user to talk into a microphone of their local electronic machine. The system may be configured to track the relative distances of the user to others. The system may be configured to provide directional audio from the received audio of the user from their microphone and replay the audio to other users within a proximity of the user in the virtual environment, and/or play the audio in a way associated with the relative positioning/orientation of the user's avatars relative to each other.

In an exemplary embodiment, the user interface may include visualizations to the user. As illustrated, the visualizations may include images 208A of other users within proximity of the user's avatar within the immersive environment, and/or within the same room or area of the virtual environment.

In an exemplary embodiment, the user interface may include objects 224, 220 configured to provide a user interaction interface to the user. For example, a screen 220 may be provided to the user that may provide audio and/or visual information to the user. In an exemplary embodiment, the screen 220 may be used to display images, words, and/or videos to the user. In an exemplary embodiment, the screen 220 may be used as a socket for interface with other programs that may be used within the environment. For example, the screen 220 may be a socket for a user to retrieve documents from a company's document management system. The screen may be a socket for other programs, such as, for example, email, documents, videos, presentations, spreadsheets, etc. The immersive environment, for example, may mimic a working environment. The user may, through their avatar, engage a computer screen or other object 224, 220 within the environment and connect to another program to operate directly within the immersive environment. In an exemplary embodiment, the system may permit a user to engage a socket, such as by navigating in proximity to the object and then initiating the socket by entering a user input. The system may be configured for the user to enter a key, button, etc. in order to launch another program through the socket displayed through the object. In an exemplary embodiment, the system may be configured to change the user interface so that the program may be expanded or otherwise redisplayed on the user interface and not limited to the object within the immersive environment.

FIG. 2D illustrates a fourth representative immersive environment according to embodiments described herein. Exemplary embodiments of the systems and methods described herein may include smart assistants in the environment. For example, as seen in FIG. 2D, a user interface may be configured with any combination of a virtual assistant 230, or one or more displays 232, 234 in any visual orientation, shape, and/or object.

Exemplary embodiments of the platform described herein may include a smart assistant. The smart assistant may be configured as a brand ambassador, tour guide, or assistant. For example, as illustrated, the smart assistant may be represented as a virtual entity, such as a person. Other entities may be used such as mascots or other interactive entity, a robot, an animal, a made-up object, an object, etc. As a user interacts or navigates a space, the smart assistant may be configured to provide information to the user. For example, if the user is attempting to interact with a screen or browse items within a virtual space, the smart assistant may provide information related to the inputs and/or outputs or other actions of the user. If the user is searching for information, for example, the smart assistant may provide tips or pointers on how to conduct their search and/or where to search. If the user is searching for a product, the smart assistant may provide related products or alternative products to assist the user in their activities. The smart assistant may provide information to teach users about using interfaces and/or technology within the environment. For example, if the user is trying to post on a social media page or create a spreadsheet, the smart assistant may provide tutorials for performing the actions of the user.

In an exemplary embodiment, the smart assistant may be a virtual presence in the virtual environment so that the user may approach and interact with the assistant in a similar way as with another user. A user may talk to the smart assistant using voice inputs and/or speaker outputs, or through text inputs, or other using input/outputs. In an exemplary embodiment, the smart user may present information without a prompt from the user and/or may respond to inquiries from the user.

In an exemplary embodiment, smart assistants may be used to interact with people and/or screens within the environment to assist users. In an exemplary embodiment, smart assistants may act in a role of a project manager, search interface, sales expert, marketing and social media expert, accountant, security expert, recorder, etc.

In an exemplary embodiment, the smart assistant as a virtual entity may work with one or more displays within the virtual platform and/or may be the displays themselves without a separate virtual avatar image. For example, if a user is searching for art from a specific artist, or a specific product, the smart assistant may provide accessors for the request, such as frames, or related objects commonly purchased with the specific product on other displays in the environment, and/or may display alternative products related to the search, and/or may display information about the product, such as reviews, values, sales, origin, etc., and/or may display information about the brand or origin of the search.

In an exemplary embodiment, the smart assistant may use one or more displays in the virtual environment. Exemplary embodiments of the smart assistant may, for example, perform any combination of diverse tasks such as, for example, presenting products and/or services, scheduling meetings, providing summary of meetings, overseeing projects, providing project plans and/or deadlines, KPIs, sales or customer support, etc. For example, a smart assistant may be present in a meeting conducted in the virtual environment. The smart assistant may be present and may provide an interaction with users in the meeting. The smart assistant may provide transcription and/or recording of the meeting, may provide a summary of the meeting, may provide action items or projects for the meeting, may provide reminders about actions, events, or schedules set during the meeting, or any combination thereof. The users may interact with the smart assistant by asking the smart assistant to do certain actions, such as, for example, setting a deadlines, adding dates or events to calendars, sending reminders, tracking activities, etc.

Exemplary embodiments of the smart assistant may use program instructions, machine learning or other artificial intelligence to train or determine how the smart assistant will act and/or respond in the virtual environment.

Exemplary embodiments of the smart assistant may be customized by the owner of the virtual space and/or by users of the system. For example, a user and/or virtual space owner may select different smart assistants that have been trained on different combination of data sets to provide different experiences with the system. Exemplary embodiments may be configured and/or selected based on different objectives, services, processes, etc. For example, a smart assistant may be configured as a product expert, meeting manager, salesperson, educator, trainer, or some other defined purpose. The smart assistant may therefore be trained to achieve the specific purpose for achieving the desired results. Users and/or owners of a virtual space may be able to configure their user interface in order to achieve a desired result.

Exemplary embodiments may permit a user to schedule the presence of a smart assistant, such as when scheduling a meeting. Exemplary embodiments may provide a user interface to permit a user to select a smart assistant based on one or more purposes when navigating to a given virtual area, such as a given room. For example, an avatar entering a conference room may be presented with an option to invite or have a smart assistant trained on meeting actions join the virtual area, while an avatar entering a sales floor with products for purchase may be presented with an option to invite or have a smart assistant trained on merchandise or sales or searching into the virtual area.

An exemplary embodiment may use a smart assistant for facilitating user engagement. In an exemplary embodiment, the virtual environment may be used to facilitate user meetings or provide a virtual meeting location. One or more avatars may be configured to navigate to a given room or identified virtual area within the virtual environment. One or more of the users may select a smart assistant to join the virtual area. The smart assistant may be configured to track a meeting. The smart assistant may use one or more displays within the virtual area to provide information from the virtual assistant. For example, a meeting virtual assistant may use a display to provide transcription of what is spoken within the virtual area or those inside the virtual room. The meeting virtual assistant may use a display to provide an agenda or provide an image of documents or other information to the group that has been referenced in the meeting and indicated as available for display for the meeting participants. The meeting virtual assistant may use a display to show project action items and/or summaries of the meeting. The virtual assistant may use a plurality of displays to show the desired information. The virtual assistant may provide a user visual experience that may move between information on the display as relevant to what is occurring within the virtual area. The virtual assistant may, for example, scroll between different screens or information on a single display or move between slides of a presentation.

Although described herein in terms of an avatar being present within the virtual environment to act as a visual representation of a smart interface, the system does not require a representation of the assistant. Instead, exemplary embodiments may provide virtual interface directly through a user interface, such as a screen or other user input/output virtual representation.

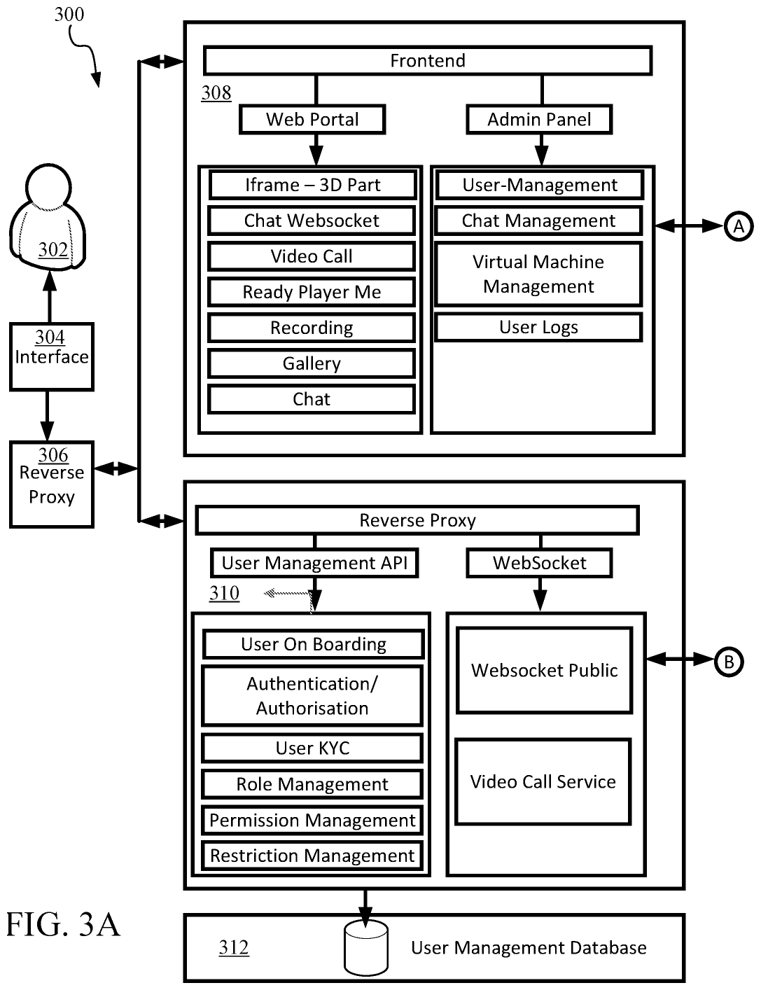

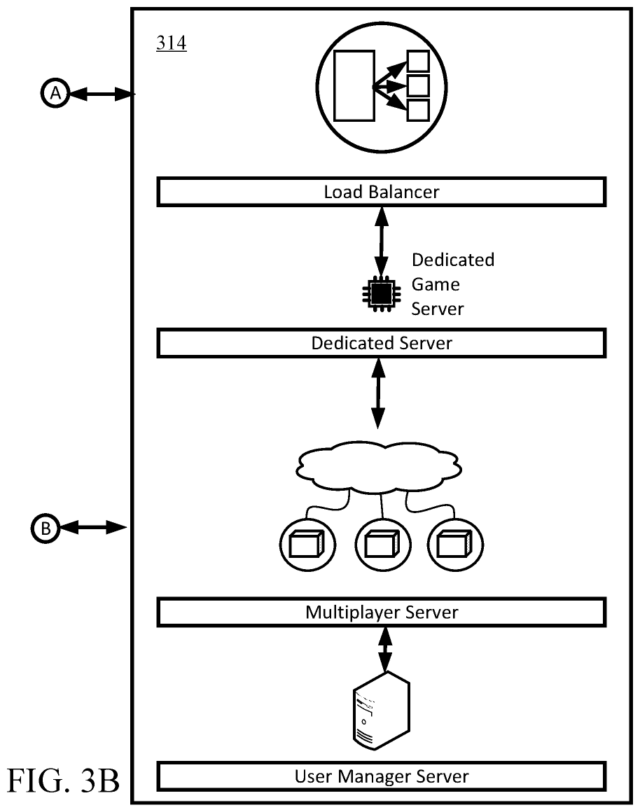

FIGS. 3A-3B illustrate an exemplary block diagram of a system architecture according to embodiments of an immersive system described herein.

In an exemplary embodiment, the system may include a three-dimensional computer graphics engine. Unreal engine (UE) is shown and described herein. Exemplary embodiments of the three-dimensional computer graphics engine features a high degree of portability, supporting a wide range of desktop, mobile, console, and virtual reality platforms.

In an exemplary embodiment, the system includes pixel streaming. Pixel streaming may be configured to allow users to avoid downloading large sized files. In an exemplary embodiment, instead of downloading files to a user's machine, a user can access a digital product through a link and interact with a source file placed within the three-dimensional computer graphics engine.

In an exemplary embodiment, the system may include a web portal. Exemplary embodiments may use any language, however, HTML and/or typescript are exemplary languages for creating the web portal. Exemplary embodiments of the application components may define many views, arranged hierarchically, in which a router server may be used to define navigation paths among views. Exemplary embodiments of the architecture of the application for creating the web portal may include organized components into modules. Exemplary embodiments of the modules may be configured to collect related code into functional sets. An application may be defined by a set of modules. An application may include a root module for enabling bootstrapping, and one or more feature modules. Components may be configured to define views, which may be sets of screen elements that the platform may choose among and modify according to the program logic and data. Components may be configured to use services, which provide specific functionality not directly related to views. Service providers may be injected into components as dependencies, permitting modular, reusable, and efficient code. Exemplary embodiments of the modules, components, and services may be configured as classes that use decorators. The decorators may be configured to mark their type and provide metadata used by the platform to indicate how the module, component, and service should be used. Exemplary embodiments of the metadata for a component class may be associated with a template that defines a view. A template may be configured to combine ordinary HTML with directives and binding markup that allow the platform to modify the HTML before rendering it for display. The metadata for a service class may provide the information to the platform needed to make it available to components through dependency injection (DI).

Referring to FIG. 3A, the system may be used by a user 302. The user may access the immersive system described herein through a client device. The client device may be an electronic device having a screen. The screen may be a display, virtual reality device, augmented reality device, or a combination thereof. The client device may, for example, include a laptop, desktop, smart phone, tablet, google or visual display for augmented or virtual reality systems.

As illustrated in FIG. 3A, the user 302 may interface with the system through a user interface 304 on the client device. The user interface 304 may have attributes similar to the front-end page 102 as described with respect to FIG. 1. The user interface may be configured to display a real-time three-dimensional representation of the immersive environment using a reverse proxy 306. The exemplary reverse proxy may be configured as a server that acts as an intermediary between client devices and a web server. The reverse proxy may be configured to forward client requests to the web server and returning the server's responses back to the clients. An exemplary reverse proxy may provide security, load balancing and other services for web servers. It can also improve performance and user experience by providing features like Secure Socket Layer (SSL) offloading, caching, and content acceleration.

As illustrated in FIG. 3A, the system may include a front-end 308. The front-end may be configured as the part of the web application responsible for the user interface and user experience. It may include features of displaying features and providing audio to the user on a user client device, such as through a screen, display, augmented or virtual reality google, or other user output device. Exemplary embodiments of the front-end 308 may comprise features of the application on the client-side of the application. Exemplary embodiments may therefore run on the user's device, such as in a web browser. The front-end 308 may be configured for presenting the data and functionality provided by the back-end (the server side of the application) to the user in a visual and interactive manner.

In an exemplary embodiment, the front-end 308 may comprise a web portal. Exemplary embodiments of the web portal may provide user interface options for the user to log in, register, and enjoy the website features according to exemplary embodiments describe herein. For example, the web portal may be configured to permit users to interact with the three-dimensional immersive environment, chat using a web socket, video calling, make or modify an avatar, record all or portions of the immersive environment, review recorded or captures experiences from the immersive experience, use any incorporated program, or any combination thereof.

In an exemplary embodiment, the web interface may be configured to permit users to conduct and/or join an audio or audio/video call. The system may be configured with a user interface, to permit the user to select or receive a user input indicating an intent to initiate a call. For example, the user input may be configured to identify a call by identifying a room, or a meeting or group may be identified by a room name that is entered by a user through a text box or drop-down selection or other user input. Virtual navigation to a location within the immersive environment may also be used to indicate an intent to initiate a call or join a call. Therefore, anyone entering a room may then join the audio and/or audio/video call. The user may enter a room or indicate an intent to join a call by indicating a name of a room and/or by navigating within the immersive environment to a room. Exemplary embodiments of the system may be configured to permit the user to control the call by providing a user list of those that are present in the call, provide videos of one or more of the user's within the call, permit video control, such as in sharing screens and/or data and/or programs, permit controls, such as to mute, unmute, and/or end the call, or any combination thereof.

In an exemplary embodiment, the web interface may be configured to permit users to record an experience within the immersive environment. The system may therefore be configured to capture a screen and record the immersive environment, and/or any portion or combination of portions of the immersive environment. The system may therefore be configured to receive a user input indicating an intent to record the immersive environment. The system may also be configured to receive another user input indicating an area or portion of the immersive environment, such as a given portal, socket, room, area, etc. within the immersive environment. The system may be configured to obtain permissions and/or providing notice of the recording or intent to record the immersive experience. The system may be configured to capture the screen in order to record an image and/or series of images to create a video recording of the experience. The system may then record and/or save the recording in a gallery or memory location in which a user may retrieve and replay at a later time.

In an exemplary embodiment, the web interface may be configured to permit users to replay recordings at a later time. The recording may be audio, video, or audio/video. The playback may be of a recording of the platform itself as described herein. The system may be configured to retrieve audio/video data from memory and play the data. The system may be configured to receive a user input from a user to identify a desired audio/video to play. The system may be configured to retrieve the audio/video from memory, and/or playing the selected audio/video within the immersive environment. The player may be configured to play the audio/video to the user and/or to a group of users, such as in a video call according to embodiments described herein.

In an exemplary embodiment, the web interface may be configured to permit users to participate in a common exchange of text messages and/or images. For example, the users may participate in a chat exchange through a chat web socket. The system may be configured to permit user inputs of text or selection of images or other files to share with other users. The system may be configured to receive a user input and share information on the platform. For example, the system may be configured to connect the user to a chat interface, such as by navigating the avatar of the user to a room or area within the immersive environment, engaging with a user interface of the immersive environment, receiving a user input, or a combination thereof. The system may be configured to share message notification when a user sends and/or receives text or communications from other users. The system may be configured to display a list of users and/or list of messages shared through the system.

In an exemplary embodiment, the web interface may be configured to permit users to book an event and/or create a calendar invite. The system may be configured to receive a user input to provide a date and/or time, select one or more other users, and/or create an event for others to participate at the designated date/time. In an exemplary embodiment, the system may be configured to create and/or play an audio, video, or audio/video at the designated date/time.

In an exemplary embodiment, the web interface may be configured to broadcast all or part of the immersive experience or portions of the interface to users on one or more other display systems. For example, the system may be configured to broadcast portions of the immersive experience through the platform to another display, such as a screen or television.

In an exemplary embodiment, the web interface may be configured to permit access to one or more other programs. The system may be configured with one or more sockets in which a user may access the program through the immersive environment. In an exemplary embodiment, the sockets may be displayed through an object as described herein. For example, conventional work programs may be configured to be accessed through a user interface appear as a screen or display within the immersive environment. The system may be configured to receive user inputs to launch and/or manipulate the program through the user interface of the immersive environment. For example, the system may track a user location and/or orientation. The user may navigate their avatar to a specific location and/or orientation within the immersive environment, such as facing an object or contacting a portal as described herein. The system may be configured to receive a user input indicating a program or launch of the program within the socket. For example, the user may press a button when in proximity to the virtual object within the immersive environment to launch a program on the interface of the object.

In an exemplary embodiment, the system may be configured with an inline frame (iframe). The platform may be a web based platform, supported as an HTML page. The iframe may be an HTML element that loads another HTML page within the original page. The iframe may be used to put a webpage or online function as an inserted page within the immersive environment as the parent page. Exemplary embodiments of the iframe element, or HTML element within the parent HTML page, may be used for advertisements, videos, analytics, interactive content, audio content, video content, document presentation or manipulation, presentation display or manipulation, spreadsheet presentation or manipulation, other data display or manipulation, program display or manipulation, or combinations thereof.

In an exemplary embodiment, the front-end 308 may comprise an administration panel or portal. Exemplary embodiments of the admin portal may manage access of users and manage the services of the user portal. For example, the administrative panel may include options for user management, chat management, virtual machine management, or tracking or management of user logs. For example, the administrative portal may be configured with user information, credential information, access information, logs, and other data on the use of the system. As described herein, the system may permit access to certain users into restricted areas and/or restricted functions. In these cases, the system may be configured to track the identity of the user and/or permissions relative to the restrictive areas, access, and/or functions. The system may be configured to automatically authenticate a user and permit or deny access to the areas and/or functions based on the authentication and the user permissions contained in the administrative panel as the user attempts to access the areas and/or functions. In an exemplary embodiment, the system may be configured to authenticate a user by receiving access credentials from the user when the user attempts to access a restrictive area and/or function, and then authenticate the user credential and permit or deny access.

As described herein, the system may be access through a user interface 304 through a reverse proxy 306. The reverse proxy may comprise functions according to embodiments described herein. For example, the reverse proxy 310 may manage communications to and/or from a user including through application programming interfaces (APIs) and/or web sockets.

Exemplary embodiments of the system described herein may use application programming interfaces (APIs). APIs may include a set of protocols, routines, and tools for building software and applications. An API may be configured to define how different software components can interface and exposes the functionality of a system, library, or service to be used by other software systems. Exemplary embodiments of the APIs described herein may be configured to allow different software systems to communicate with each other, enabling functionality to be shared and reused. For example, a web-based e-commerce platform might use an API to allow third-party developers to access its product information and inventory data to build custom applications or integrate with other systems. Exemplary embodiments of the APIs may be configured to enable seamless integration and interoperability between different systems and technology.

Exemplary embodiments described herein may use APIs configured to implement any combination of features, including, for example: user onboarding, authorization and authentication, user know your customer/client (KYC), role management, permission management, restriction management, etc.

Exemplary embodiments of the system described herein may use web socket(s). Web sockets described herein may be configured for bidirectional, real-time communication between a client and a server over a single, long-lived connection. Exemplary embodiments of web sockets described herein enable full-duplex communication so that data can be sent and received simultaneously in both directions, allowing for real-time interactions and updates. Alternatively, embodiments may use hypertext transfer protocol (HTTP) instead of or in combination with web sockets. However, the single, persistent connection between the client and the server, reducing overhead of establishing and tearing down connection for each request may be preferred to separate connection of HTTP based communication. Embodiments of the systems described herein may use web sockets implemented using the web sockets protocol and/or APIs, which may be available through the web browser and/or web servers. Exemplary embodiments of the web sockets described herein may be used to integrate different combination of functionality into the platform, such as, for example, any combination of real-time communication, gaming, chat applications, video conferencing applications, real time data exchange, real time financial market information, collaborative applications, user applications, programs, or combinations thereof. Exemplary embodiments of the web sockets described herein may provide lower latency, reduced overhead, and/or improved scalability and/or performance as compared to HTTP based communication.

Exemplary embodiments described herein may use web socket(s) configured to implement any combination of features, including, for example: chat, user status (offline/online), user join and leave activity, user information communication, etc.

In an exemplary embodiment, the reverse proxy 310 may include a web socket for real time communication including interactive voice and video exchanges. In an exemplary embodiment, the video call service may comprise Agora®, a real time communication platform for interactive voice and video experiences. The exemplary video call service may include APIs and/or software development kit (SDK) for developers to build high-quality, scalable, and reliable communication experiences for their applications. Exemplary embodiments of the video call service described herein provides voice and video calling, live broadcasting, and interactive gaming, among other features. Exemplary embodiments of the video call service may comprise a cloud-based infrastructure for real time communication, providing low latency and high reliability. Exemplary embodiments of the video call service may include security features, including, for example, encryption to ensure that communication is secure and private.

Exemplary embodiments described herein may include a system database 312. Exemplary embodiments of the database may be configured to organize collections of structured data that can be accessed, managed, and updated by users and/or applications. Exemplary embodiments of the databases described herein may be used to store and manage data, including text, numbers, multimedia content, user credentials, user information, access credentials, calendar or event information, recordings, or other information as described herein. Exemplary embodiments may include any combination of central and/or distributed memory locations to form the database as described herein. Exemplary embodiments of the database described herein may include any combination of relational databases, SQL databases, NoSQL databases, in-memory databases, etc. Exemplary embodiments of the databases described herein may be managed and/or maintained by database management system (DBMS), which may provide tools and/or interfaces for creating, updating, and retrieving data in the database. Exemplary embodiments of the platform described herein may be configured to save data of the user like email, name, profile, virtual machine related details, and status, etc.

FIG. 3B illustrates an exemplary architecture used in combination with the front-end and reverse proxy of FIG. 3A, including a combination of different servers 314. For example, exemplary embodiments of the systems described herein for generating an immersive environment may include any combination of servers, such as, for example, a game server, user management server, multiplayer server, load balancer server, or combinations thereof. Exemplary servers may include one or more servers for any of the layers described herein, such as with respect to FIG. 1, for example, such as a back end server, application dedicated server, streaming matchmaking server, exported application server, and/or three dimensional streaming server.

Exemplary embodiments of the system described herein may include a game server. Exemplary embodiments of the game server may be used to run executable files. In an exemplary embodiment, the game server may be used in combination with the load balancer layer as described herein. For example, the system may be configured so that one user entering the platform may initiate one virtual machine (VM). Exemplary embodiments of the game server may be used to configure the virtual machine. Exemplary embodiments described herein may include internet information services (IIS) server. The IIS server may be configured inside the virtual machine and used for requests, SSL certificate, URL rewrite, reverse proxy, and/or site management.

Exemplary embodiments of the system described herein may include one or more user management server(s). An exemplary user management server may be configured to manage the users and/or the user activities.

Exemplary embodiments of the system described herein may include one or more multiplayer servers. An exemplary multiplayer server may be configured to connect a plurality of users in a single room. Exemplary embodiments of the multiplayer server may be configured so that each user may run their own executable file but may also collaborate with other users. Exemplary embodiments described herein may be automatically generated using the real-time three-dimensional creation tool described herein.

Exemplary embodiments of the system described herein may include a load balancer server. An exemplary load balancer server may be configured to manage the one or more game servers. The game servers may be the virtual machines that contain game executable files for each user. Exemplary embodiments of the load balancer server may be configured to create and/or terminate virtual machines according to user requests. Exemplary embodiments of the system described herein may manage virtual machine in tables. For example, the system may include two tables, such as a prebuild VM and a user allocated VM. In an exemplary embodiment, the prebuild VM may be initially created in the server, and the load balancer server may be configured to manage the count of the virtual machines. In an exemplary embodiment, the system may load a predetermined number of virtual machines (preloaded virtual machines). When a user requests access to the platform, the load balancer may assign one virtual machine from the preloaded virtual machines. The system may be configured to load another virtual machine to maintain a desired predetermined number of preloaded virtual machines for use by the next user. The preloaded virtual machines may permit efficient and fast access to the system. In an exemplary embodiment, the user allocated VM table may be configured as a list of virtual machines that are occupied by users. One user may correspond to one virtual machine.

Exemplary embodiments of the system described herein may be configured to uniquely identify each user. In an exemplary embodiment, when a user creates a request to connect with the web server, the web server is configured to save cookies on the user's browser to uniquely identify that user. When a user is connected with a given communication exchange, and/or game, then the system may receive and track an identifier of the user, such as their email. In an exemplary embodiment, the identifier may be sent in a query field that permits the system to know which user connects on which virtual machine. Exemplary embodiments of the server(s) described herein may save device id, email, user identifier, or other user information, credentials, etc. when the user connects with a virtual machine.

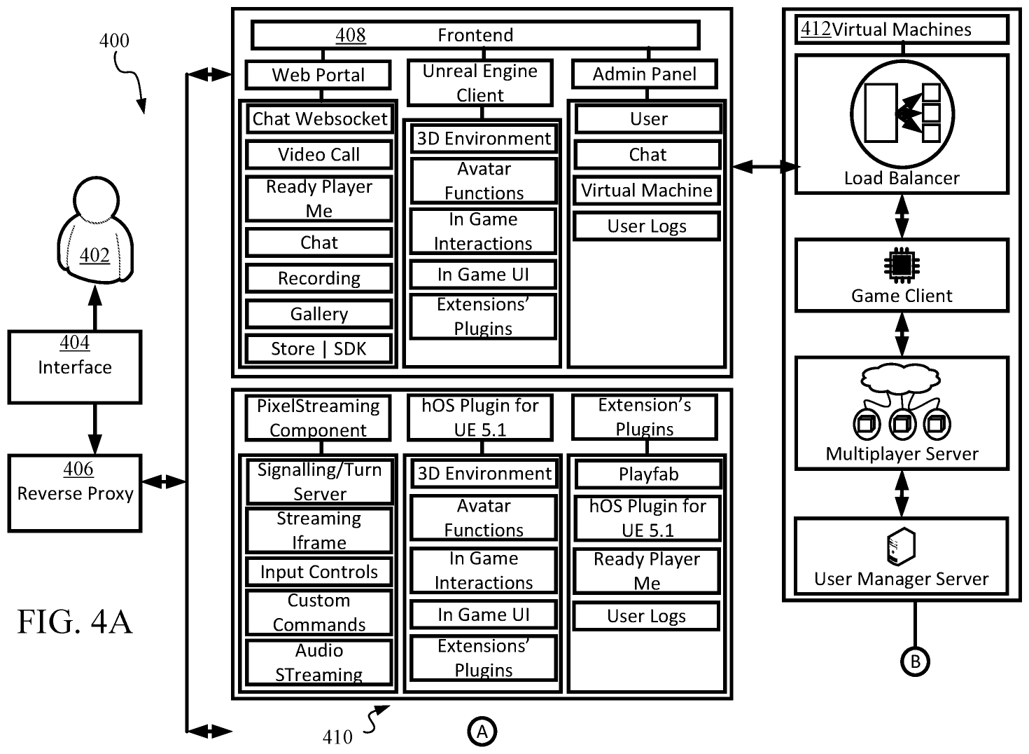

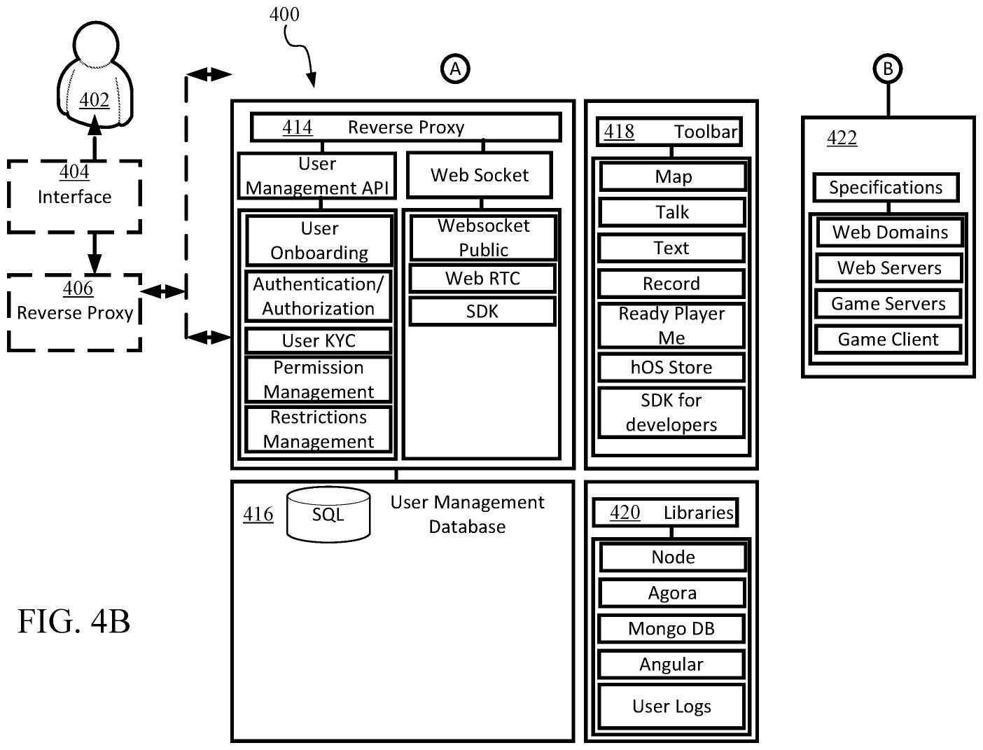

FIGS. 4A-4B illustrates an exemplary block diagram of a system architecture according to embodiments of an immersive system described herein. Similar to FIG. 3A-3B, the exemplary embodiment of the immersive system described herein may permit a user 402 to access the system through a user interface 404 through a reverse proxy 406. The user interface 404 through a reverse proxy 406 may be similar to the embodiments described with respect to FIGS. 3A-3B and include any of the modules and/or features described with respect to other embodiments.

Referring to FIG. 4A, the system may be used by a user 402. The user may access the immersive system described herein through a client device. The client device may be an electronic device having a screen. The screen may be a display, virtual reality device, augmented reality device, or a combination thereof. The client device may, for example, include a laptop, desktop, smart phone, tablet, google or visual display for augmented or virtual reality systems.

As illustrated in FIG. 4A, the user 402 may interface with the system through a user interface 404 on the client device. The user interface 404 may have attributes similar to the front-end page 102 as described with respect to FIG. 1. The user interface may be configured to display a real-time three-dimensional representation of the immersive environment using a reverse proxy 406. The exemplary reverse proxy may be configured as a server that acts as an intermediary between client devices and a web server. The reverse proxy may be configured to forward client requests to the web server and returning the server's responses back to the clients. An exemplary reverse proxy may provide security, load balancing and other services for web servers. It can also improve performance and user experience by providing features like Secure Socket Layer (SSL) offloading, caching, and content acceleration.

As illustrated in FIG. 4A, the system may include a front-end 408. The front-end may be configured as the part of the web application responsible for the user interface and user experience. It may include features of displaying features and providing audio to the user on a user client device, such as through a screen, display, augmented or virtual reality google, or other user output device. Exemplary embodiments of the frontend 408 may comprise features of the application on the client-side of the application. Exemplary embodiments may therefore run on the user's device, such as in a web browser. The front-end 408 may be configured for presenting the data and functionality provided by the backend (the server side of the application) to the user in a visual and interactive manner.

In an exemplary embodiment, the front-end 408 may comprise a web portal. Exemplary embodiments of the web portal may provide user interface options for the user to log in, register, and enjoy the website features according to exemplary embodiments describe herein. For example, the web portal may be configured to permit users to interact with the three-dimensional immersive environment, chat using a web socket, video calling, make or modify an avatar, record all or portions of the immersive environment, review recorded or captures experiences from the immersive experience, use any incorporated program, or any combination thereof. Exemplary embodiments of the web portal are described herein and may include any features of the web portals described herein, such as those of the front end 308 of FIG. 3A.

In an exemplary embodiment, the frontend 408 may comprise an administration panel or portal. Exemplary embodiments of the admin portal may manage access of users and manage the services of the user portal. For example, the administrative panel may include options for user management, chat management, virtual machine management, or tracking or management of user logs. For example, the administrative portal may be configured with user information, credential information, access information, logs, and other data on the use of the system. As described herein, the system may permit access to certain users into restricted areas and/or restricted functions. In these cases, the system may be configured to track the identity of the user and/or permissions relative to the restrictive areas, access, and/or functions. The system may be configured to automatically authenticate a user and permit or deny access to the areas and/or functions based on the authentication and the user permissions contained in the administrative panel as the user attempts to access the areas and/or functions. In an exemplary embodiment, the system may be configured to authenticate a user by receiving access credentials from the user when the user attempts to access a restrictive area and/or function, and then authenticate the user credential and permit or deny access.

In an exemplary embodiment, the frontend 408 may comprise an advanced real-time three-dimensional creation tool for immersive experiences. As illustrated, the advanced real-time three-dimensional creation tool may be the unreal engine. The creation tool may be configured to generate the three-dimensional immersive environment for display to the user. The creation tool may be configured to generate an avatar for representing a location and orientation of the user within the immersive environment. The creation tool may be configured to control the avatar functions. The creation tool may be configured to generate user interface features of the immersive environment and/or in the interactions of the avatar with respect to other avatars, portals, rooms, doors, or virtual objects within the immersive environment.

In an exemplary embodiment, the system includes pixel streaming. Pixel streaming may be configured to allow users to avoid downloading large sized files. In an exemplary embodiment, instead of downloading files to a user's machine, a user can access a digital product through a link and interact with a source filed placed within the three-dimensional computer graphics engine.

In an exemplary embodiment, the system may be configured for streaming. Components described herein may be configured to define views, which may be sets of screen elements that the platform may choose among and modify according to the program logic and data. Components may be configured to use services, which provide specific functionality not directly related to views. Pixel streaming may be configured to allow users to avoid downloading large sized files. In an exemplary embodiment, instead of downloading files to a user's machine, a user can access a digital product through a link and interact with a source file placed within the three-dimensional computer graphics engine. Pixel streaming may include one or more of the servers and/or functions described herein. For example, the system may include a server configured to control peer-to-peer connections. As another example, the system may include a server for streaming components within an inline frame (iFrame) as described herein. As another example, the system may include input controls and/or customer commands as described herein to start, end, control, and/or interact with the system described herein including moving the avatar, communicating with programs, functions, etc. within the system described herein.

In an exemplary embodiment, the front end may be configured for plugins for use in one or more browser environments and/or to permit one or more functions. In an exemplary embodiment, the system may be configured to display on one or more different browsers, such as, for example, universal explorer. The universal explorer plug in may operate similar to the real-time three-dimensional creation tool. Other extension plugins may also or alternatively be provided in the system to permit additional features and/or functions described herein.

In an exemplary embodiment, the system may include a reverse proxy 414 according to embodiments described herein. Exemplary embodiments of the reverse proxy may be similar to the reverse proxy described herein, such as the reverse proxy 306, 314 as described with respect to FIG. 3A. Exemplary embodiments of the reverse proxy 414 described herein may include API(s) and/or web socket(s).

In an exemplary embodiment, the system may include a database 416. The database may be configured as one or more memory for storing data as described herein.

In an exemplary embodiment, the front-end may provide a toolbar 418 for use by the user of the platform. As illustrated, the toolbar 418 may include selections for user inputs that permit the user to take advantage of the features and functions described herein. For example, the toolbar may permit a user to join a video or audio call, and/or chat group. The toolbar 418 may include an option to display a map of the immersive environment. The map may include information such as where the user is currently within the immersive environment. The map may include information about functions, locations, objects, portals, and/or other features of the immersive environment as described herein. The map may be configured to permit the user to enter a user input, such as a selection on the map to move the avatar of the user to different locations within the immersive environment. The toolbar 418 may be configured to permit a user to record the immersive experience and/or capturing one or more images, audio recordings, and/or video recordings of the immersive experience. The toolbar 418 may be configured to permit the selection of additional features and/or functions provided through the system. For example, developers or third parties may develop additional features and provide selections and/or user interfaces to permit the user to engage the functions through the toolbar 418. In an exemplary embodiment, the toolbar 418 may be a collection of different icons to make a user selection to start or end the use of one or more functions described herein.

In an exemplary embodiment, the system may include libraries in order to support the functions described herein. Exemplary embodiments of the libraries may include the code libraries of the programs described herein to perform the functions described herein. For example, exemplary libraries may include real time engagement platform for voice and/or video communication; platform for building mobile and/or desktop web applications, platform for services and tools to distributive applications and/or data storage, managing user logs and/or authentication, etc.

Exemplary embodiments of the system described herein may include one or more servers 412 to perform the functions described herein. For example, the system may include a load balancing server, game server, multiplayer server, user manager server, etc. For example, exemplary embodiments of the systems described herein for generating an immersive environment may include any combination of servers, such as, for example, a game server, user management server, multiplayer server, load balancer server, or combinations thereof. Exemplary servers may include one or more servers for any of the layers described herein, such as with respect to FIG. 1, for example, such as a back-end server, application dedicated server, streaming matchmaking server, exported application server, and/or three-dimensional streaming server.

In an exemplary embodiment, a server may be used to run executable files. In an exemplary embodiment, a server may be used in combination with the load balancer layer as described herein. For example, the system may be configured so that one user entering the platform may initiate one virtual machine (VM). Exemplary embodiments of the game server may be used to configure the virtual machine. Exemplary embodiments described herein may include internet information services (IIS) server. The IIS server may be configured inside the virtual machine and used for requests, SSL certificate, URL rewrite, reverse proxy, and/or site management.

Exemplary embodiments of the system described herein may include a load balancer server. An exemplary load balancer server may be configured to manage the one or more game servers. The game servers may be the virtual machines that contain game executable files for each user. Exemplary embodiments of the load balancer server may be configured to create and/or terminate virtual machines according to user requests. Exemplary embodiments of the system described herein may manage virtual machine (VM) in tables. For example, the system may include two tables, such as a prebuild VM and a user allocated VM. In an exemplary embodiment, the prebuild VM may be initially created in the server, and the load balancer server may be configured to manage the count of the virtual machines. In an exemplary embodiment, the system may load a predetermined number of virtual machines (preloaded virtual machines). When a user requests access to the platform, the load balancer may assign one virtual machine from the preloaded virtual machines. The system may be configured to load another virtual machine to maintain a desired predetermined number of preloaded virtual machines for use by the next user. The preloaded virtual machines may permit efficient and fast access to the system. In an exemplary embodiment, the user allocated VM table may be configured as a list of virtual machines that are occupied by users. One user may correspond to one virtual machine.

Exemplary embodiments of the system described herein may include one or more multiplayer servers. An exemplary multiplayer server may be configured to connect a plurality of users in a single room. Exemplary embodiments of the multiplayer server may be configured so that each user may run their own executable file but may also collaborate with other users. Exemplary embodiments described herein may be automatically generated using the real-time three-dimensional creation tool described herein.

Exemplary embodiments of the system described herein may include a user manager server. In an exemplary embodiment, the user manager server may be configured to uniquely identify each user. In an exemplary embodiment, when a user creates a request to connect with the web server, the web server is configured to save cookies on the user's browser to uniquely identify that user. When a user is connected with a given communication exchange, and/or game, then the system may receive and track an identifier of the user, such as their email. In an exemplary embodiment, the identifier may be sent in a query field that permits the system to know which user connects on which virtual machine. Exemplary embodiments of the server(s) described herein may save device id, email, user identifier, or other user information, credentials, etc. when the user connects with a virtual machine.

Exemplary embodiments of the system described herein may include web platform specifications 422. For example, the system may include a web domain for accessing the platform. Webservers and game servers may be provided that render the immersive environment and communicate with the browsers to provide the user interface to the user. The user may use an electronic device, such as a client device (game client) on the front end to view the platform described herein. Specifications may be provided to manage the communication between the servers, clients, browsers, domains, etc.

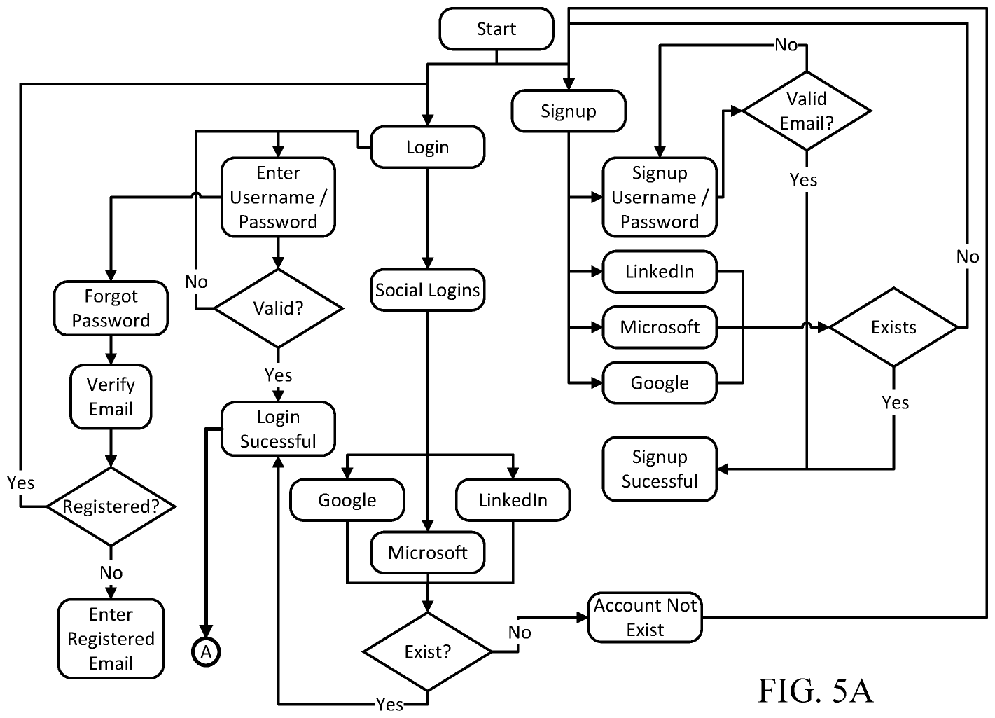

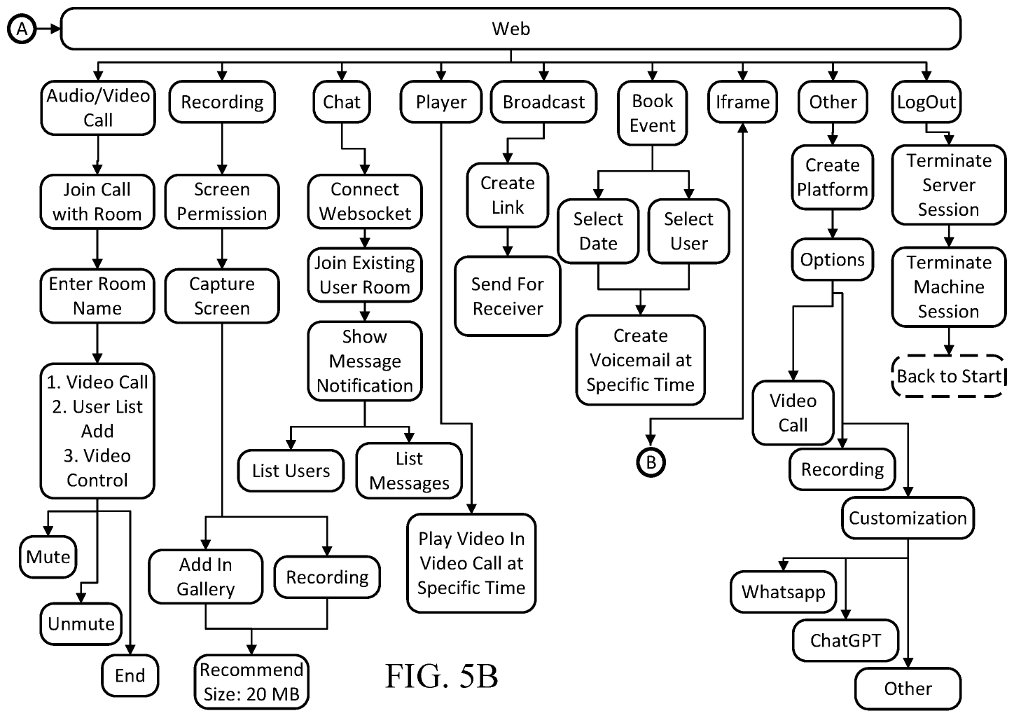

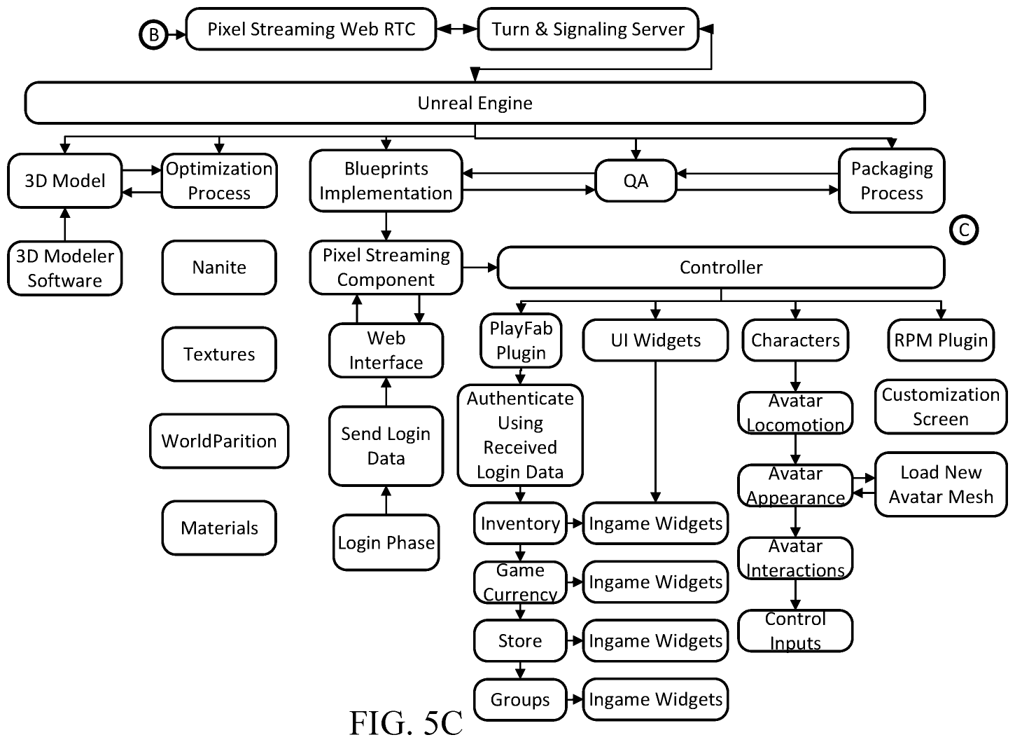

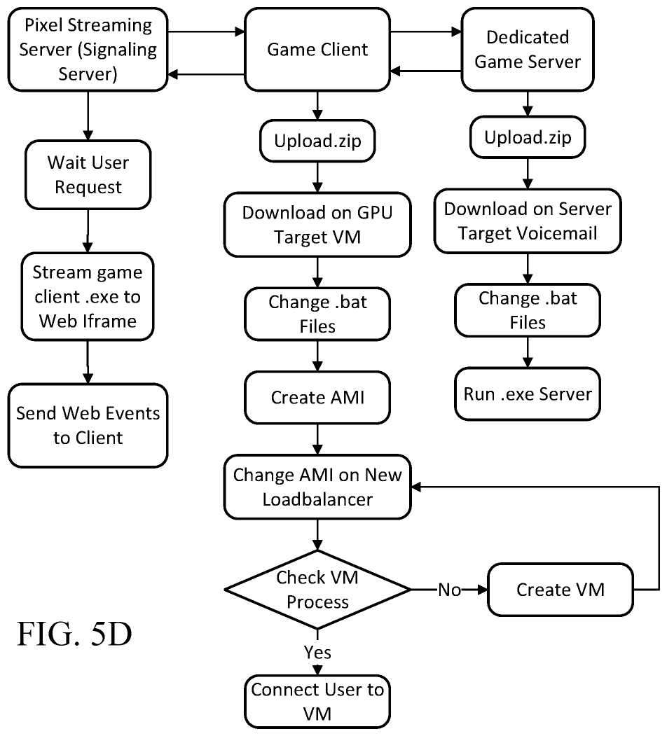

FIGS. 5A-5D illustrate an exemplary method for using the platform according to embodiments described herein. A user may start by signing up or signing into the platform.

FIG. 5A illustrates an exemplary portion of the method according to embodiments described herein to log a user into the system.

If the user is new to the system, the system may be configured to allow the user to log into the system. The method may start with the user signing up to permit access to the user. The signup process may permit the user to enter a username, passport, and/or other login credentials. The method may also or alternatively permit the user to identify one or more other login credential, such as through another media platform. As illustrated, LinkedIn®, Microsoft®, or Google® accounts are representative as examples in which the system may link another account to permit access to the instant platform. The system is then configured to confirm that the login credentials are valid and/or exist. If they exist, then the signup may be successful. The system may be configured to store the log in credentials in a database to be used for a later login according to embodiments described herein.

If the user is already registered, the user may log into the system. According to the original registration, the user may use a username, password, or other credential, and/or may permit a user to select a linked account in order to authenticate the user and log the user into the platform. The method may include receiving user credentials and confirming whether the user has an account and logging the user into the system. The system is configured to receive a user credential, compare the user credential to an authentication credential previously registered with the system. The system is then configured to confirm the authentication of the user and permit the user to access the user, deny the user access to the platform, and/or permit the user to register to the platform.

After a user is authenticated, and confirmed as a user of the platform, the user may have access to the web interface. The method may permit a user to enter a web address, such as through a uniform resource locator (URL) in a web browser. The user may be provided a user interface permitting the user to enter user credentials. The system may then confirm the user is permitted access to the system, and if authenticated, permit the user to interact with one or more remote servers to experience the immersive environment.

FIG. 5B illustrates exemplary options available to a user through the web interface through the immersive environment. In an exemplary embodiment, the user may perform one or more combination of functions through the web interface.

In an exemplary embodiment, the web interface may be configured to permit users to conduct and/or join an audio or audio/video call. The method may include starting and conducting an audio and/or audio/video call. The method may, for example, receive a user input indicating an intent to initiate a call. The method may identify a call by identifying a room. For example, as illustrated herein, a meeting or group may be identified by a room name. Anyone entering a room such as by controlling an avatar to a specific area within the immersive environment may then join the audio and/or audio/video call. The user may enter a room or indicate an intent to join a call by indicating a name of a room and/or by navigating within the immersive environment to a room. Exemplary embodiments may then permit the user to control the call by providing a user list of those that are present in the call, provide videos of one or more of the users within the call, permit video control, such as in sharing screens and/or data and/or programs, permit controls, such as to mute, unmute, and/or end the call, or any combination thereof.

In an exemplary embodiment, the web interface may be configured to permit users to record an experience within the immersive environment. The method may therefore be configured to receive a user input indicating an intent to record the immersive environment. For example, the method may include receiving a user input, such as a selection of an icon of the user presented through the user interface of the immersive environment. The method may also (optionally) include receiving another user input indicating an area or portion of the immersive environment, such as a given portal, socket, room, area, etc. within the immersive environment. The method may include obtaining permissions and/or providing notice of the recording or intent to record the immersive experience. The method may then include capturing the screen to record an image and/or series of images to create a video recording of the experience. The method may then record and/or save the recording in a gallery or memory location in which a user may retrieve and replay later.

In an exemplary embodiment, the web interface may be configured to permit users to replay recordings later. The recording may be audio, video, or audio/video. The playback may be of a recording of the platform itself as described herein. The system may be configured to retrieve audio/video data from memory and play the data. The method may include receiving a user input from a user to identify a desired audio/video to play. The method may include retrieving the audio/video from memory, and/or playing the selected audio/video within the immersive environment. The player may be configured to play the audio/video to the user and/or to a group of users, such as in a video call according to embodiments described herein.

In an exemplary embodiment, the web interface may be configured to permit users to participate in a common exchange of text messages and/or images. For example, the users may participate in a chat exchange. The method may include receiving a user input and sharing information on the platform. For example, the method may include connecting the user to a chat interface, such as by navigating to a room or area within the immersive environment, engaging with a user interface of the immersive environment, receiving a user input, or a combination thereof. The method may include sharing message notification when a user sends and/or receives text from other users. The method may include displaying a list of users and/or list of messages shared through the system.

In an exemplary embodiment, the web interface may be configured to permit users to book an event and/or create a calendar invite. The method may include booking an event. The method may include receiving a user selection of a date and/or time for an event. The method may include creating the event at the given time and/or date. The method may include sending information to other users to participate in the event. The method may include accepting or declining participation in the event.

In an exemplary embodiment, the web interface may be configured to broadcast all or part of the immersive experience or portions of the interface to users on one or more other display systems. For example, the system may be configured to broadcast portions of the immersive experience through the platform to another display, such as a screen or television.

In an exemplary embodiment, the web interface may be configured to permit access to one or more other programs. The system may be configured with one or more sockets in which a user may access the program through the immersive environment. In an exemplary embodiment, the sockets may be displayed through an object as described herein. For example, conventional work programs may be configured to be accessed through a user interface appear as a screen or display within the immersive environment. The system may be configured to receive user inputs to launch and/or manipulate the program through the user interface of the immersive environment. For example, the system may track a user location and/or orientation. The user may navigate their avatar to a specific location and/or orientation within the immersive environment, such as facing an object or contacting a portal as described herein. The system may be configured to receive a user input indicating a program or launch of the program within the socket. For example, the user may press a button when in proximity to the virtual object within the immersive environment to launch a program on the interface of the object.

In an exemplary embodiment, the system may be configured with an inline frame (iframe). The platform may be a web-based platform, supported as an HTML page. The iframe may be an HTML element that loads another HTML page within the original page. The iframe may be used to put a webpage or online function within the immersive environment as the parent page. Exemplary embodiments of the iframe element, or HTML element within the parent HTML page, may be used for advertisements, videos, analytics, interactive content, audio content, video content, or combinations thereof.

FIG. 5C illustrates an exemplary embodiment to support the integration of different functions within the immersive three-dimensional environment. Exemplary embodiments of the platform may be used to stream the visual characteristics of the immersive environment to the user. Exemplary embodiments of the system may use a server to permit users to transmit and receive streams to and/or from peers. In an exemplary embodiment, the system may include an engine for real-time three-dimensional creation and rendering for the immersive experience.

In an exemplary embodiment, the system may be configured to stream the visual of the immersive environment run on a cloud/network platform. The streaming may permit the platform to run without the need for specific software to be stored on the user's machine. In an exemplary embodiment, pixel streaming may be accomplished using WebRTC through a browser on the user's machine.

In an exemplary embodiment, the system may be configured with a server used to let peers transmit streams to each other. Exemplary embodiments therefore permit peer-to-peer streams. The exemplary server may be configured to manage the connections between peers. In an exemplary embodiment, the server may be configured for signaling, enabling one peer to find another in the network, negotiating the connection, resetting the connection if needed, and closing it down.

In an exemplary embodiment, the system may be configured with an engine for real-time three-dimensional creation and rendering for photoreal visuals and immersive experiences.

FIG. 5C illustrates an exemplary method and components for rendering the three-dimensional immersive environment. For example, the system and method may include a controller that may be used to manage user interface widgets, characters, including avatar location, appearance, interactions, movement, etc. The system and method may include optimization, three-dimensional modeling, three dimensional rendering, modules for rendering textures, world partitioning, materials, etc.

FIG. 5D illustrates an exemplary method and components for streaming and rending the three-dimensional immersive environment. FIG. 5D is a portion of FIG. 5C and provides additional method and modules for the rending of the dimensional immersive environment at the indicator circle C. Exemplary embodiments may include a streaming server, game server, game client that are configured to communicate with each other.

Exemplary embodiments described herein include a system having a web server; an application dedicated server configured to provide session persistence to a virtual three-dimensional immersive environment; a web-enabled user interface resident on the web server, wherein the web-enabled user interface is configured to present web pages to a browser application on a client machine to solicit information from a user and control a display of the immersive environment.

The system may include any combination of features, such as, for example: a matchmaking server configured to initiate a virtual machine when a new streaming connection is opened for a new user joining the platform, wherein the virtual machine; and/or a reverse proxy configured to manage communication between the client machine to the web server.

In an exemplary embodiment, the system may include any additional features. For example, the web server and matchmaking server are separate servers. For example, the web-enabled user interface may be configured as the virtual three-dimensional immersive environment. For example, the user interface comprises an object presented in the virtual three-dimensional immersive environment. For example, the object comprises a web socket to integrate another program into the virtual three-dimensional immersive environment. For example, the object may be configured to permit communicate using audio streaming, video streaming, text, or a combination thereof. For example, the object may be configured to transport an avatar of the user into another portion of the immersive environment when the avatar contacts the object.

Exemplary embodiments described herein may include a system including an application dedicated server configured to provide session persistence to a virtual three dimensional immersive environment; a backend server configured to control audio corresponding to a position within the virtual three dimensional immersive environment; a streaming matching server configured to manage a number of streaming connections to the system, and create a virtual machine when a new user enters the system; an application configured render the virtual three dimensional immersive environment, track avatar movement, and track avatar location; a streaming server configured to stream graphics from the application to a web-enabled user interface; and the web-enabled user interface, wherein the web-enabled user interface is configured to present web pages to a browser application on a client machine to solicit information from a user and control a display of the virtual three dimensional immersive environment.

Exemplary embodiments of the method described herein may include providing a virtual three-dimensional immersive environment. The method may include providing the virtual three-dimensional immersive environment on a user interface; receive a user input for moving an avatar within the virtual three-dimensional immersive environment on the user interface; and join a video, audio, text, or combination thereof exchange between users of the virtual three-dimensional immersive environment.

Exemplary embodiments of the method may include any combination of additional steps. For example, the method may include accessing a program through a web portal within the virtual three-dimensional immersive environment. For example, the method may include navigating the avatar to a secure area within the virtual three-dimensional immersive environment, wherein the secure area is accessed once the user is authenticated to enter the secure area. Exemplary embodiments may include the program being accessed through the web portal by navigating the avatar to within a proximate location of the object within the virtual three-dimensional immersive environment.

The computing devices described herein are non-conventional systems at least because of the use of non-conventional component parts and/or the use of non-conventional algorithms, processes, and methods embodied, at least partially, in the programming instructions stored and/or executed by the computing devices. For example, as describe throughout the instant specification, unique attributes are provided herein for providing the desired persistence of the environment, scaling to accommodate the dynamic user base, high-quality and low latency streaming, immersive experience, protection, unique environment, and other attributes provided herein.

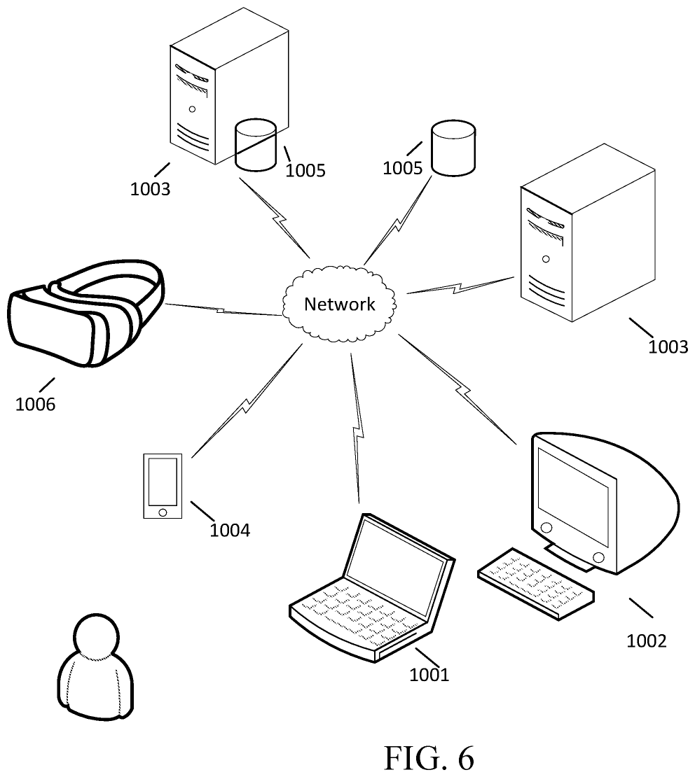

FIG. 6 illustrates exemplary network systems for creating the immersive environment described herein. Exemplary embodiments of the system for creating an immersive environment described herein may include a computer, computers, electronic device, or electronic devices. As used herein, the term computer(s) and/or electronic device(s) are intended to be broadly interpreted to include a variety of systems and devices including personal computers 1002, laptop computers 1002, mainframe computers, servers 1003, set top boxes, digital versatile disc (DVD) players, mobile phone 1004, tablet, smart watch, smart displays, televisions, and the like. A computer can include, for example, processors, memory components for storing data (e.g., read only memory (ROM) and/or random-access memory (RAM), other storage devices, various input/output communication devices and/or modules for network interface capabilities, etc. For example, the system may include a processing unit including a memory, a processor, an analog-to-digital converter (A/D), a plurality of software routines that may be stored as non-transitory, machine-readable instruction on the memory and executed by the processor to perform the processes described herein. The processing unit may be based on a variety of commercially available platforms such as a personal computer, a workstation a laptop, a tablet, a mobile electronic device, or may be based on a custom platform that uses application-specific integrated circuits (ASICs) and other custom circuitry to carry out the processes described herein. Additionally, the processing unit may be coupled to one or more input/output (I/O) devices that enable a user to interface to the system. By way of example only, the processing unit may receive user inputs via a keyboard, touchscreen, mouse, scanner, button, or any other data input device and may provide graphical displays to the user via a display unit, which may be, for example, a conventional video monitor. The system may also include one or more large area networks, and/or local networks for communicating data from one or more different components of the system. The one or more electronic devices may therefore input a user interface for displaying information to a user and/or one or more input devices for receiving information from a user. The system may receive and/or display the information after communication to or from a remote server 1003 or database 1005.

Exemplary embodiments of the systems described herein for generating an immersive environment may include any combination of servers 1003, such as, for example those with respect to FIGS. 3A-4B, such as, a game server, user management server, multiplayer server, load balancer server, user manager server, or combinations thereof. Exemplary servers may include one or more servers for any of the layers described herein, such as with respect to FIG. 1, for example, such as a back end server, application dedicated server, streaming matchmaking server, exported application server, and/or three dimensional streaming server.

Exemplary embodiments of the system described herein for generating an immersive environment may include a user interface. Exemplary user interfaces may be displayed on electronic devices, such as, for example, laptop 1001, computer 1002, augment or virtual reality googles 1106, or mobile device (phone or tablet), 1004.

Exemplary embodiments of the system described herein can be based in software and/or hardware. While some specific embodiments of the invention have been shown the invention is not to be limited to these embodiments. For example, most functions performed by electronic hardware components may be duplicated by software emulation. Thus, a software program written to accomplish those same functions may emulate the functionality of the hardware components in input-output circuitry. The invention is to be understood as not limited by the specific embodiments described herein, but only by scope of the appended claims.

As used herein, the terms “about,” “substantially,” or “approximately” for any numerical values, ranges, shapes, distances, relative relationships, etc. indicate a suitable dimensional tolerance that allows the part or collection of components to function for its intended purpose as described herein. Numerical ranges may also be provided herein. Unless otherwise indicated, each range is intended to include the endpoints, and any quantity within the provided range. Therefore, a range of 2-4, includes 2, 3, 4, and any subdivision between 2 and 4, such as 2.1, 2.01, and 2.001. The range also encompasses any combination of ranges, such that 2-4 includes 2-3 and 3-4.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims. Specifically, exemplary components are described herein. Any combination of these components may be used in any combination. For example, any component, feature, step or part may be integrated, separated, sub-divided, removed, duplicated, added, or used in any combination and remain within the scope of the present disclosure. Embodiments are exemplary only, and provide an illustrative combination of features, but are not limited thereto.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

1. A system comprising:
a web server;
an application dedicated server configured to provide session persistence to a virtual three-dimensional immersive environment; and
a web-enabled user interface resident on the web server, wherein the web-enabled user interface is configured to present web pages to a browser application on a client machine to solicit information from a user and control a display of the virtual three-dimensional immersive environment.

2. The system of claim 1, further comprising:
a matchmaking server configured to initiate a virtual machine when a new streaming connection is opened for a new user joining the platform.

3. The system of claim 2, further comprising a reverse proxy configured to manage communication between the client machine and the web server.

4. The system of claim 2, wherein the web server and the matchmaking server are separate servers.

5. The system of claim 1, wherein the web-enabled user interface is configured as the virtual three-dimensional immersive environment.

6. The system of claim 5, wherein the web-enabled user interface comprises an object presented in the virtual three-dimensional immersive environment.

7. The system of claim 6, wherein the object comprises a web socket to integrate another program into the virtual three-dimensional immersive environment.

8. The system of claim 6, wherein the object is configured to permit communication using audio streaming, video streaming, text, or a combination thereof.

9. The system of claim 6, wherein the object is configured to transport an avatar of the user into another portion of the virtual three-dimensional immersive environment when the avatar contacts the object.

10. A system comprising:
an application dedicated server configured to provide session persistence to a virtual three-dimensional immersive environment;
a backend server configured to control audio corresponding to a position within the virtual three-dimensional immersive environment;
a streaming matching server configured to manage a number of streaming connections to the system, and to create a virtual machine when a new user enters the system;
an application configured to render the virtual three-dimensional immersive environment, track avatar movement, and to track avatar location;
a streaming server configured to stream graphics from the application to a web-enabled user interface; and
the web-enabled user interface, wherein the web-enabled user interface is configured to present web pages to a browser application on a client machine to solicit information from a user and control a display of the virtual three-dimensional immersive environment.

11. A method for providing a virtual three-dimensional immersive environment, comprising:
providing the virtual three-dimensional immersive environment on a user interface;
receive receiving a user input for moving an avatar within the virtual three-dimensional immersive environment on the user interface; and
joining a video, audio, text, or combination thereof exchange between users of the virtual three-dimensional immersive environment.

12. The method of claim 11, further comprising:
accessing a program through a web portal within the virtual three-dimensional immersive environment.

13. The method of claim 12, further comprising navigating the avatar to a secure area within the virtual three-dimensional immersive environment, wherein the secure area is accessed once the user is authenticated to enter the secure area.

14. The method of claim 12, wherein the program is accessed through the web portal by navigating the avatar to within a proximate location of the object within the virtual three-dimensional immersive environment.

15. The method of claim 11, further comprising:
providing by a smart assistant during the exchange between the users, providing information about the exchange.
